(19) United States
(12) Patent Application Publication
(10) Pub. No.: US 2014/0140759 A1
(43) Pub. Date: May 22, 2014

(54) COUPLING ASSURANCE ASSEMBLY FOR AN INTERMEDIATE SHAFT CONNECTION IN A STEERING COLUMN

(71) Applicants: Joen C. Bodtker, Gaines, MI (US); Donald A. Buzzard, Saginaw, MI (US)

(72) Inventors: Joen C. Bodtker, Gaines, MI (US); Donald A. Buzzard, Saginaw, MI (US)

(21) Appl. No.: 13/683,048

(22) Filed: Nov. 21, 2012

(51) Int. Cl. F16B 21/00

(52) U.S. Cl. CPC B62D 1/20
USPC 403/322.2

(57) ABSTRACT

A coupling assurance assembly for an intermediate shaft in a steering column is provided. The assembly includes a shaft having a longitudinal bore extending a first longitudinal axis and a fastening receptacle for receiving a fastener, a yoke having a cross hole for receiving the fastener, and a biasing device configured to urge the shaft and the yoke apart from each other.

### BACKGROUND OF THE INVENTION

The following description relates to a coupling assurance assembly for an intermediate shaft in a steering column, and in particular, a coupling assurance assembly configured to prevent an improper connection between the intermediate shaft and an adjacent shaft in the steering column.

An intermediate shaft is commonly positioned in a steering column between an output shaft of the steering column, i.e., a steering shaft, and an input shaft of a steering gear. The intermediate shaft is used to transfer steering torque from the output shaft to the input shaft of the steering gear.

A conventional intermediate shaft may include a tubular shaft element and a solid shaft element telescoped into the tubular shaft element. A yoke assembly, for example, of a universal joint assembly, may be used to couple the intermediate shaft to an adjacent shaft. In one configuration, the intermediate shaft may include a first inner yoke rigidly attached at a first end of the intermediate shaft and a second inner yoke rigidly attached at a second end of the intermediate shaft. The first inner yoke is coupled to a first outer yoke of the input shaft of the steering gear and the second inner yoke is coupled to a second outer yoke of the output shaft of the steering column, for example, with a cross trunnion or spider. The first and second outer yokes may be fixed to the respective input shaft and output shaft by way of a bolt extending through the respective yoke and shaft.

Improper coupling between the intermediate shaft and an adjacent shaft, such as the steering shaft may lead to loss of steering function. Improper coupling may result from a yoke being joined to an adjacent shaft without a bolt to secure the yoke to the adjacent shaft. In this scenario, the shaft and yoke may appear to be properly joined during assembly. However, the yoke and adjacent shaft may later separate causing loss of steering function because they are not secured to one another with the bolt or other fastener. Also, the yoke and shaft may be assembled but the bolt is fastened outside of an interlocking area between the yoke and shaft, or the bolt may be prematurely installed so that it does not secure the yoke and shaft together.

Accordingly, it is desirable to provide an assembly where improper connections between the intermediate shaft and adjacent shafts are visually detectable so that improper connections may be identified and corrected.

### SUMMARY OF THE INVENTION

According to an exemplary embodiment of the present invention, there is provided a coupling assurance assembly for an intermediate shaft in a steering column including a shaft having a longitudinal bore extending a first longitudinal axis and a fastening receptacle for receiving a fastener, a yoke having a cross hole for receiving the fastener, and a biasing device configured to urge the shaft and the yoke apart from each other.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a cross section of a coupling assurance assembly for an intermediate shaft in a steering column according to an exemplary embodiment of the present invention;

FIG. 2 is a cross section of the coupling assurance assembly of FIG. 1 in an assembled condition, according to an exemplary embodiment of the present invention;

FIG. 3 is a cross section of a coupling assurance assembly according to an alternative exemplary embodiment of the present invention;

FIG. 4 is a cross section of the coupling assurance assembly of FIG. 3 in an assembled condition, according to an exemplary embodiment of the present invention;

FIG. 5 is a cross section of a coupling assurance assembly according to another alternative exemplary embodiment of the present invention;

FIG. 6 is a perspective view of a yoke of the coupling assurance assembly of FIG. 5 having a biasing device positioned thereon according to an exemplary embodiment of the present invention;

FIG. 7 shows the biasing device of FIGS. 5 and 6 according to an exemplary embodiment of the present invention;

FIG. 8 is a cross section of the coupling assurance assembly of FIG. 5 in a partially assembled condition, according to an exemplary embodiment of the present invention;

FIG. 9 is a cross section of the coupling assurance assembly of FIG. 5 in an assembled condition according to an exemplary embodiment of the present invention; and

FIG. 10 is a cross section of another exemplary embodiment of the coupling assurance assembly of FIGS. 5-9 in a partially assembled condition.

### DETAILED DESCRIPTION

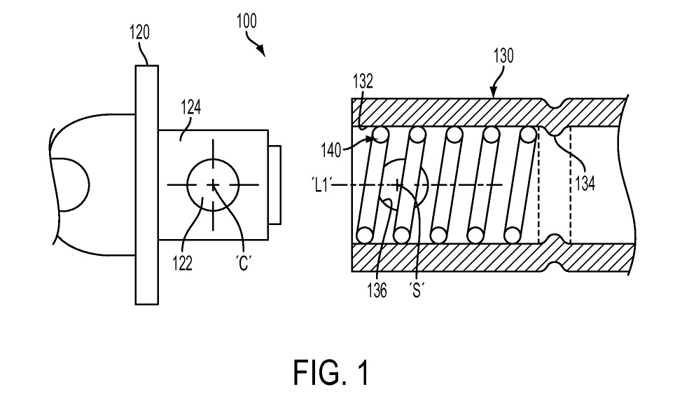

Referring now to the Figures, where the invention will be described with reference to specific embodiments, without limiting same, FIG. 1 is a cross section of a coupling assurance assembly 100 used with an intermediate shaft in a steering column according to an exemplary embodiment of the present invention. The coupling assurance assembly 100 includes a yoke 120, a shaft 130 and a biasing device 140.

With further reference to FIG. 1, the yoke 120 includes a cross hole 122 extending through an attaching section 124 of the yoke 120. The cross hole 122 extends along a cross yoke axis ‘C’ and is configured to receive a fastener (not shown) when the coupling assurance assembly is in an assembled condition. In an exemplary embodiment, the yoke 120 is a U-joint yoke that is connected at one end to the intermediate shaft (not shown) of the steering column. The attaching section 124 is positioned at an end opposite to the one end.

The shaft 130 extends along a first longitudinal axis ‘L1’ and includes a bore 132. The bore 132 has a diameter or width, i.e., an inner diameter/width of the shaft 130, that is larger than an outer diameter of the attaching section 124 of the yoke 120, so that the attaching section 124 may be received within the bore 132. A seat 134 extends around the bore 132 and serves as a seat for the biasing device 140 within the bore 132. In an exemplary embodiment, the shaft 130 is a steering column shaft.

The shaft 130 further includes a fastening receptacle 136. In an exemplary embodiment, the fastening receptacle 136 is an opening 136 extending through the shaft 130 in a direction perpendicular to the first longitudinal axis ‘L1’. In an exemplary embodiment, the opening 136 extends along a cross shaft axis ‘S’ that intersects the first longitudinal axis ‘L1’. The opening 136 may be formed as two diametrically opposed openings centered on the cross shaft axis ‘S’, extending through the shaft 130 and in communication with the bore 132.

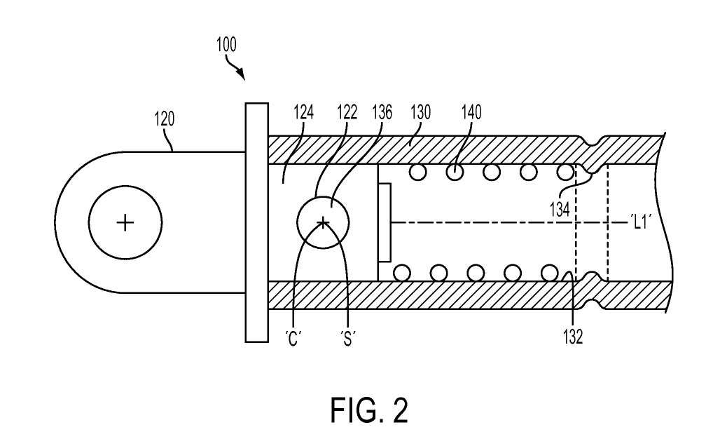

The biasing device 140 is seated on the seat 134 in the bore 132 of the shaft. The biasing device 140 is movable between a first position where it extends across the opening 136 of the shaft 130 (FIG. 1) and a second position where it is clear of the opening 136 (FIG. 2). The biasing device 140 is biased toward the first position and extends across the opening 136 in an unloaded or uncompressed condition. The biasing device 140 may be compressed by the attaching section 124 of the yoke 120 when the attaching section 124 is received within the bore 132 of the shaft 130.

In an exemplary embodiment the biasing device 140 is a coil spring. In an exemplary embodiment, the coil spring extends from the seat 134 to an open end of the shaft 130, or beyond, when uncompressed. The coils of the coil spring 140 may be spaced so that the fastener cannot be forced through spaces between the coils. In addition, in an exemplary embodiment, with the attaching section 124 fully inserted into the bore 132 of the shaft, the coil spring is not at a solid height. That is, in the second position, a spacing may be maintained between the coils of the coils spring. The coil spring 140 may be centered on the first longitudinal axis ‘L1’. However, it is understood that the coil spring may be suitably disposed in off-axis positions as well.

FIG. 2 is a cross section of the coupling assurance assembly 100 of FIG. 1 in an assembled condition, according to an exemplary embodiment of the present invention. With reference to FIG. 2, the attaching section 124 of the yoke 120 is received within the bore 132 of the shaft 130 and moves the biasing device 140 from the first position to the second position. In the second position, as shown in FIG. 2, the biasing device 140 is compressed within the bore 132 to a position where it is clear of, i.e., does not extend across, the opening 136 of the shaft 130.

In addition, in the assembled condition, the cross hole 122 of the yoke 120 is aligned with the opening 136 of the shaft 130. Accordingly, the cross yoke axis ‘C’ and the cross shaft axis ‘S’ are aligned, and the fastener (not shown) may be received through the cross hole 122 and opening 136 to fix the yoke 120, and thus, the intermediate shaft, to the shaft 130. In an exemplary embodiment, the fastener may be a bolt, or other suitable fastening mechanism.

The biasing device 140 is biased toward the first position. Thus, when the attaching section 124 of the yoke is inserted into the bore 132, the yoke 120 is urged outward from the bore 132 of the shaft 130. Accordingly, if a fastener is not installed through the cross hole 122 and opening 136, the attaching section 124, and thus the yoke 120, will be urged out of the shaft 130. Thus, improper assembly by omitting the fastener may be readily noticed and corrected before the steering column is packaged and shipped. Further still, the biasing device 140 blocks the opening 136 in the shaft 130 when in the first position. Thus, the fastener may not be received in the opening 136 if the biasing device is not compressed to a position, i.e., the second position, clear of the opening 136. Accordingly, the fastener may not be prematurely installed.

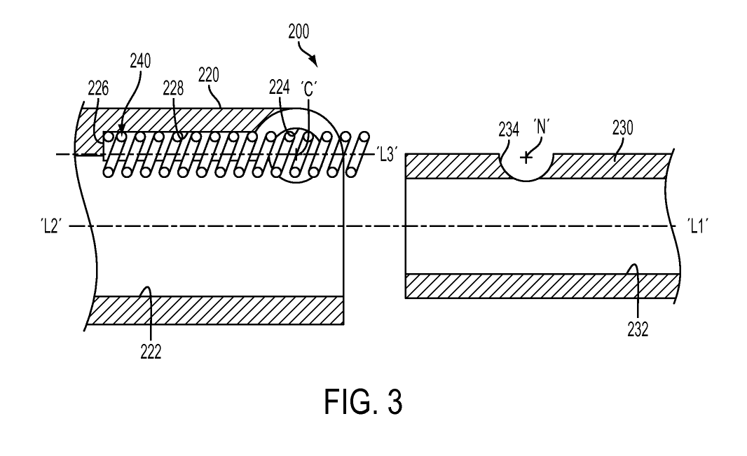

FIG. 3 is a cross section of a coupling assurance assembly 200 according to an alternative embodiment of the present invention. FIG. 3 shows the coupling assurance assembly 200 in an uncoupled condition. The coupling assurance assembly 200 includes a yoke 220, a shaft 230 and a biasing device 240.

With further reference to FIG. 3, the yoke 220 includes a yoke bore 222, a cross hole 224 and a seat 226 positioned within the yoke bore 222. The seat 226 is formed at an axial end of an internal slot 228 positioned within the yoke bore 222. In an exemplary embodiment, the yoke 220 is a clamp yoke that is connected at one end to the intermediate shaft of the steering column. The shaft 230 is positioned at an opposite end of the yoke 220 than the intermediate shaft.

The shaft 230 extends along a first longitudinal axis ‘L1’ and includes a shaft bore 232. The shaft 230 has an outer diameter/width that is less than a diameter/width of the yoke bore 222 so that the shaft 230 may be received within the yoke bore 222. In an exemplary embodiment, the shaft 230 is a steering column shaft.

The shaft 230 further includes a fastening receptacle 234. In an exemplary embodiment, the fastening receptacle 234 is a notch 234 formed in an outer periphery of the shaft 230. The notch 234, sometimes referred to as a “whistle notch”, extends along a notch axis ‘N’. In an exemplary embodiment, the notch axis ‘N’ is spaced from, and extends generally perpendicular to the first longitudinal axis ‘L1’.

The yoke bore 222 extends along a second longitudinal axis ‘L2’. The cross hole 224 extends along a cross yoke axis ‘C’. In an exemplary embodiment, the cross yoke axis ‘C’ is spaced from the second longitudinal axis ‘L2’ and extends generally perpendicular to the second longitudinal axis ‘L2’.

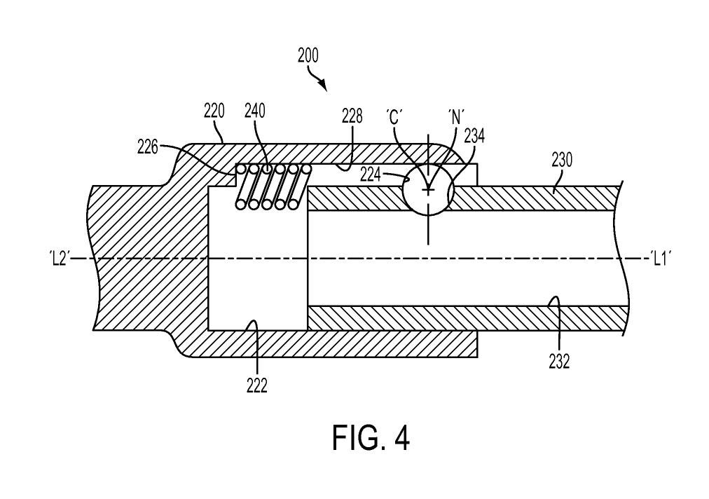

The biasing device 240 is seated on the seat 226 in the yoke bore 222. The biasing device 240 is movable between a first position where it extends across the cross hole 224 (FIG. 3) of the yoke 220 and a second position where it is clear of the cross hole 224 (FIG. 4). The biasing device 240 is biased toward the first position and extends across the cross hole 224 in an unloaded or uncompressed condition. The biasing device 240 may be compressed by the shaft 230 when the shaft 230 is received within the yoke bore 222.

In an exemplary embodiment the biasing device 240 is a coil spring and extends along a third longitudinal axis ‘L3’ within the yoke bore 222. The coil spring 240 may be positioned at least partially in the internal slot 228 of the yoke bore 222. In an exemplary embodiment, the coil spring extends from the seat 222 to an open end of the yoke bore 222, or beyond, when uncompressed. The coils of the coil spring may be spaced so that the fastener cannot be forced through spaces between the coils. The coil spring 240 may be formed with a substantially constant or varying width or diameter. The width or diameter of the coil spring 240 in the region of the cross hole 224 is sufficient to block access to the cross hole 224 by a fastener when the coil spring is in the first position. The width or diameter of the coil spring 240 may be larger than, approximately equal to, or smaller than a diameter of the cross hole 224 in the region of the cross hole 224.

FIG. 4 is a cross section of the coupling assurance assembly 200 of FIG. 3 in an assembled condition, according to an exemplary embodiment of the present invention. With reference to FIG. 4, the shaft 230 is received within the yoke bore 222 of the yoke 220 and moves the biasing device 240 from the first position to the second position. In the second position, the biasing device 240 is compressed within the yoke bore 222 to a position where it is clear of, i.e., does not extend across, the cross hole 224 of the yoke 220.

In addition, in the assembled condition, the notch 234 of the shaft 230 is aligned with the cross hole 224 of the yoke 220. Accordingly, the notch axis ‘N’ and the cross yoke axis ‘C’ are aligned so that the fastener (not shown) may be received through the cross hole 224 and the notch to secure the yoke 220, and thus, the intermediate shaft, to the shaft 230.

The biasing device 240 is biased toward the first position. Thus, when the shaft 230 is inserted into the yoke bore 222, the shaft 230 is urged outward from the yoke bore 222. Accordingly, if a fastener is not installed through the cross hole 224 and notch 234, the shaft 230 will be urged out of the yoke bore 222. Thus, improper assembly by omitting the fastener may be readily noticed and corrected before the steering column is packaged and shipped. Further still, the biasing device 240 blocks the cross hole 224 of the yoke when in the first position. Thus, the fastener may not be received in the cross hole 224 if the biasing device 240 is not compressed to a position, i.e., the second position, clear of the cross hole 240. Accordingly, premature installation of the fastener may be prevented.

In the exemplary embodiments above, the biasing device 140, 240 is a coil spring. The coil spring may be wound to fit a cross section of a shaft. For example, the coil spring may be wound as a double-D spring to fit a double-D cross section that is commonly found in shafts. In addition, the spacing between coils of the coil spring may be uneven or even. Uneven coil spacing may be desirable to minimize a solid height of the spring while maintaining a sufficient barrier against premature installation of the fastener.

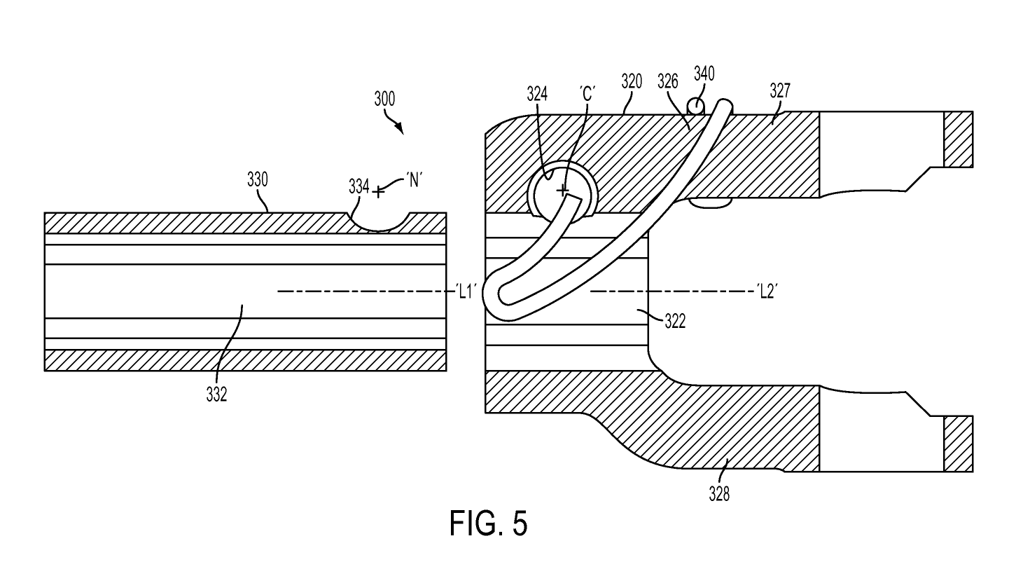

FIG. 5 is a cross section of a coupling assurance assembly 300 according to still another alternative exemplary embodiment of the present invention. FIG. 5 shows the coupling assurance assembly 300 in an unassembled condition. The coupling assurance assembly 300 includes a yoke 320, a shaft 330 and a biasing device 340.

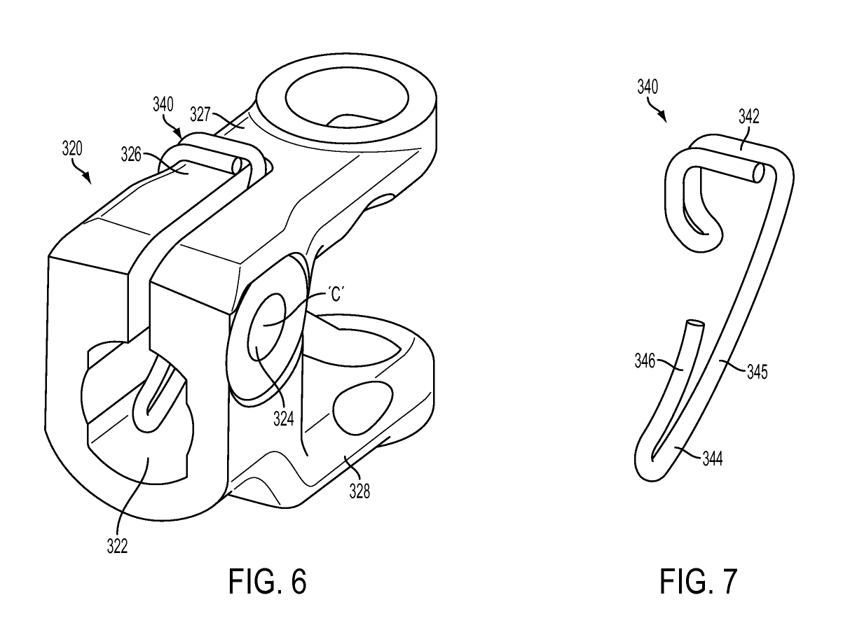

FIG. 6 is a perspective view of the yoke 330 with the biasing device 340 positioned thereon according to an exemplary embodiment of the present invention. With reference to FIGS. 5 and 6, the yoke 320 includes a yoke bore 322, a cross hole 324 and a mounting portion 326. In an exemplary embodiment, the yoke 320 is a clamp yoke having a first leg 327 and a second leg 328 spaced from the first leg 327. The mounting portion 326 is formed on one of the first leg 327 and second leg 328.

In an exemplary embodiment, the yoke 320 is connected at one end to the intermediate shaft of the steering column. The shaft 330 is positioned at an opposite end of the yoke 320 than the intermediate shaft. For example, and with reference to FIG. 6, respective distal ends of the legs 327, 328 may be fastened to another yoke that is fixed to the intermediate shaft, while the shaft 330 is received in the yoke bore 322.

Referring again to FIG. 5, the shaft 330 extends along a first longitudinal axis ‘L1’ and includes a shaft bore 332. The shaft 330 has an outer diameter/width that is less than a diameter/width of the yoke bore 322 so that the shaft 330 may be received within the yoke bore 322. In an exemplary embodiment, the shaft 330 is a steering column shaft.

The shaft 330 further includes a fastening receptacle 334. In an exemplary embodiment, the fastening receptacle 334 is a notch 334, sometimes referred to as a “whistle notch”, formed in an outer periphery of the shaft 330. The notch 334 extends along a notch axis ‘N’. In an exemplary embodiment, the notch axis ‘N’ is spaced from, and extends generally perpendicular to the first longitudinal axis ‘L1’.

The yoke bore 322 extends along a second longitudinal axis ‘L2’. The cross hole 324 extends along a cross yoke axis ‘C’. In an exemplary embodiment, the cross yoke axis ‘C’ is spaced from the second longitudinal axis ‘L2’ and extends generally perpendicular to the second longitudinal axis ‘L2’.

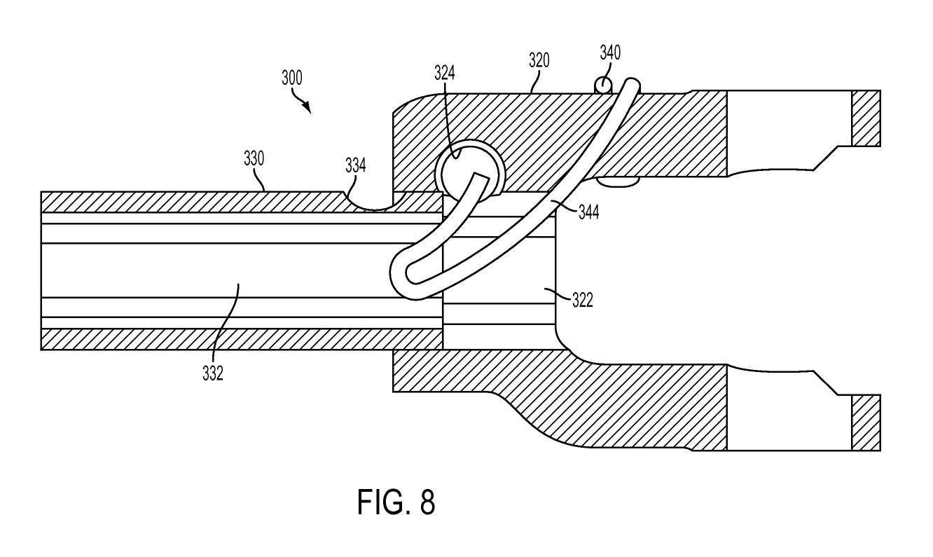

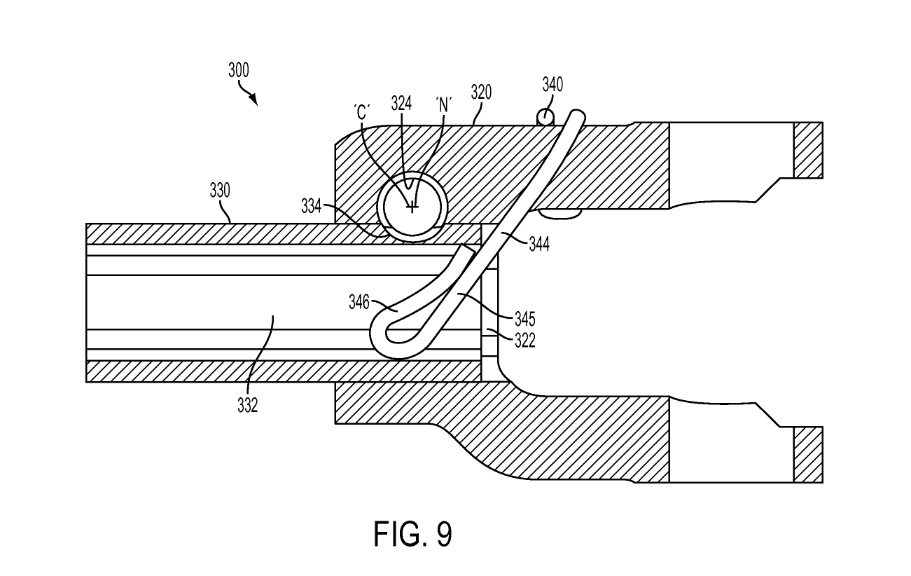

FIG. 7 shows the biasing device 340 of FIGS. 5 and 6 according to an exemplary embodiment of the present invention. In an exemplary embodiment, the biasing device 340 is a spring having securing section 342 and a blocking arm 344. The securing section 342 is configured to wrap at least partially around the mounting portion 326 of the yoke 320. The blocking arm 344 extends from the securing section 342 and is movable between a first position where it extends across the cross hole 324 of the yoke 320 (FIGS. 5 and 8) and a second position where it is clear of the cross hole 324 (FIG. 9). The biasing device 340 is biased toward the first position and extends at least partially across the cross hole 324 in an unloaded or uncompressed condition. The biasing device 340 may be deflected toward the second position by the shaft 330 when the shaft 330 is received within the yoke bore 322.

In an exemplary embodiment, the blocking arm 344 may include a first section 345 and second section 346. The first section extends from the securing section 342 and the second section 346 extends from the first section 345 at least partially across the cross hole 324.

FIG. 8 is a cross section of the coupling assurance assembly 300 of FIG. 5 in a partially assembled condition, according to an exemplary embodiment of the present invention. With reference to FIG. 8, the shaft 330 is partially received within the yoke bore 322 of the yoke 320 and comes into contact with the biasing device 340. In an exemplary embodiment, the shaft 330 comes into contact with the blocking arm 344 with the blocking arm 344 in the first position. A portion of the blocking arm may be received within the shaft bore 332.

FIG. 9 is a cross section of the coupling assurance assembly 300 of FIG. 5 in an assembled condition. Referring to FIG. 9, the shaft 330 contacts the biasing device 340 to move the biasing device 340 from the first position to the second position. In an exemplary embodiment, the shaft 330 contacts the blocking arm 344 to move the blocking arm 344 from the first position to the second position. In the second position, the blocking arm 344 is deflected within the yoke bore 322 to a position where it is clear of, i.e., does not extend across, the cross hole 324 of the yoke 320. In an exemplary embodiment, the shaft 330 contacts the second section 346 of the blocking arm 344 and deflects the first section 345 and second section 346 so that the blocking arm 344 is moved to the second position. In the assembled condition, the blocking arm 344 is at least partially received within the shaft bore 332. For example, the second section 346 of the blocking arm 344 may be received within the shaft bore 332 and the first section 345 of the blocking arm 344 may be partially received within the shaft bore 332.

In addition, in the assembled condition, the notch 334 of the shaft 330 is aligned with the cross hole 324 of the yoke 320. Accordingly, the notch axis ‘N’ and the cross yoke axis ‘C’ are aligned so that the fastener (not shown) may be received through the cross hole 324 and the notch to secure the yoke 320, and thus, the intermediate shaft, to the shaft 330.

The blocking arm 344 is biased toward the first position. Thus, during insertion of the shaft 330 into the yoke bore 322, the shaft 330 is urged outward from the yoke bore 322. In addition, the blocking arm 344 of the biasing device 340 blocks the cross hole 324 of the yoke 320 when in the first position. Thus, a fastener may not be received in the cross hole 324 if the blocking arm 344 is not deflected to a position, i.e., the second position, clear of the cross hole 340.

The blocking arm 344 is in the second position when the shaft 330 reaches a position in the yoke bore 322 where the fastener may be inserted through cross hole 324. With the blocking arm 344 in the second position, the second section 346 is received within shaft bore 332. In this position, the blocking arm 344 may operate to retain the shaft 330 in the position where the fastener may be received in the cross hole 324. For example, with the blocking arm 344 at least partially received in the shaft bore 332, an end of the first section 345 and an end of the second section 346 may engage opposite sides of an inner wall of the shaft bore 322 to resist movement of the shaft 330 in an outward direction, i.e., a direction where the shaft 330 is removed from the yoke bore 322.

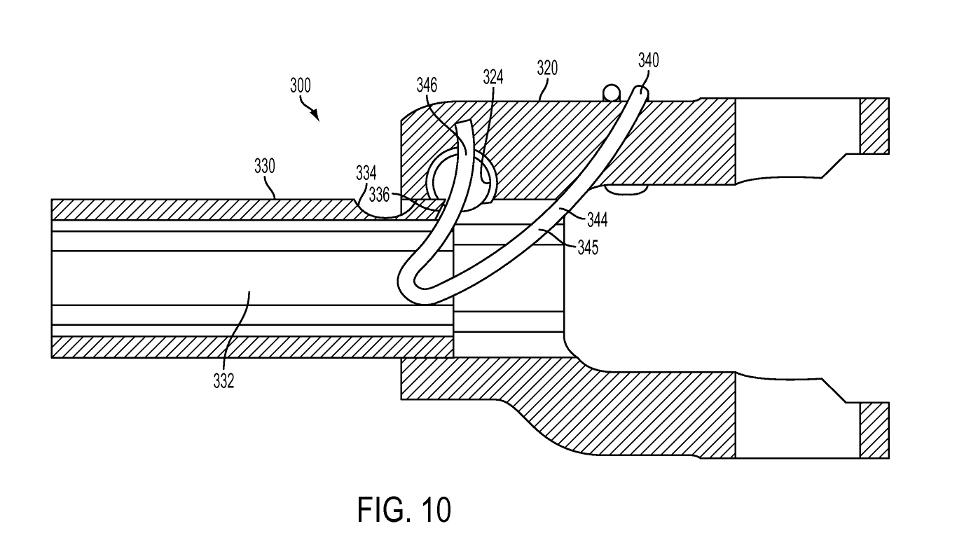

FIG. 10 is a cross section of another exemplary embodiment of the coupling assurance assembly 300 of FIGS. 5-9 in a partially assembled condition. It is understood that features similar to those described in the exemplary embodiments above are referred to with the same reference numbers as above, and that further description of these features may be omitted where these features do not differ from the features in the exemplary embodiments above.

The shaft 330 may include a retaining slot 336 at an end that comes into contact with the biasing device 340. The biasing device 340 is dimensioned to extend completely across the cross hole 324 of the yoke 320. In an exemplary embodiment, the second section 346 of the blocking arm 344 extends completely across the cross hole 324 and is received within the retaining slot 336 of the shaft 330. Further, the blocking arm 344 may be partially received within the shaft bore 332. However, the second section 346 of the blocking arm 344 is dimensioned so that it is not completely received within the shaft bore 332 when the coupling assurance assembly is assembled.

In the exemplary embodiments above, the shaft and yoke are assembled in a male/female relationship. With reference to the embodiments shown in FIGS. 3-10, the male component is shown as having a longitudinal bore. It is understood that this is shown for the purposes of example only, and is not limiting. The male component may be a solid component.

In the exemplary embodiments above, a proper coupling between a yoke that is attached to an intermediate shaft of a steering column and a shaft may be ensured. The shaft may be, for example, an output, or steering shaft of steering column positioned at one of the intermediate shaft, or an input, or gear shaft of a steering gear positioned at an opposite end of the intermediate shaft. A biasing device is positioned between the yoke and the shaft so that one is urged away from the other unless a fastener is properly installed. Thus, during assembly, if a fastener is not installed one of the yoke and shaft is urged away from the other so that is a visible indication that the yoke and shaft are not coupled. In addition, the biasing device is configured to extend across a portion of the yoke or shaft configured to receive the fastener so as to prevent insertion of the fastener. With this feature, premature installation of the fastener may be avoided, as the biasing device is not moved to a position where the fastener may be received in the yoke and/or shaft until the yoke and shaft are properly positioned relative to one another. In addition, the biasing device may be used to remove or reduce lash, i.e., space between parts resulting from part-to-part variations, between the shaft and the yoke.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A coupling assurance assembly for an intermediate shaft in a steering column, the assembly comprising:
a shaft having a longitudinal bore extending a first longitudinal axis and a fastening receptacle for receiving a fastener;
a yoke having a cross hole for receiving the fastener; and
a biasing device configured to urge the shaft and the yoke apart from each other.

2. The coupling assurance assembly of claim 1, wherein the shaft includes a seat extending circumferentially around the longitudinal bore and the biasing device is seated on the seat within the longitudinal bore.

3. The coupling assurance assembly of claim 2, wherein the fastening receptacle is an opening extending through the shaft along a cross shaft axis in a direction perpendicular to the first longitudinal axis.

4. The coupling assurance assembly of claim 3, wherein the cross shaft axis intersects the first longitudinal axis.

5. The coupling assurance assembly of claim 3, wherein the biasing device is a coil spring movable between a first position and a second position, and in the first position the coil spring extends within the longitudinal bore across the opening.

6. The coupling assurance assembly of claim 5, wherein the yoke includes an attaching section comprising the cross hole and the cross holes extends along a cross yoke axis.

7. The coupling assurance assembly of claim 6, wherein the attaching section is received within the longitudinal bore of the shaft and moves the coil spring to the second position, where the coil spring does not extend across the opening.

8. The coupling assurance assembly of claim 7, wherein the cross hole and the opening are aligned for receiving the fastener.

9. The coupling assurance assembly of claim 8, wherein the yoke is a u-joint yoke.

10. The coupling assurance assembly of claim 1, wherein the fastening receptacle of the shaft is a notch formed in an outer surface of the shaft, the notch extending along a notch axis perpendicular to the first longitudinal axis, and the notch axis spaced from the longitudinal axis.

11. The coupling assurance assembly of claim 10, wherein the yoke includes a yoke bore extending along a second longitudinal axis.

12. The coupling assurance assembly of claim 11, wherein the yoke bore has an inner diameter or width that is greater than an outer diameter or width of the shaft, such that the yoke bore is configured to receive the shaft.

13. The coupling assurance assembly of claim 12, wherein the cross hole extends through the yoke along a cross yoke axis that is spaced from the second longitudinal axis.

14. The coupling assurance assembly of claim 13, wherein the biasing device is a coil spring positioned in the yoke bore, the coil spring movable between a first position extending across the cross hole and a second position clear of the cross hole, the coil spring biased toward the first position.

15. The coupling assurance assembly of claim 14, wherein the shaft is received within the yoke bore and moves the coil spring from the first position to the second position, and the cross hole and notch aligned when the shaft is received within the yoke bore.

16. The coupling assurance assembly of claim 15, wherein the yoke is a clamp yoke.

17. The coupling assurance assembly of claim 13, wherein the biasing device is a spring clip secured to the yoke and having blocking arm moveable between a first position extending at least partially across the cross hole and a second position clear of the cross hole, the blocking arm biased toward the first position.

18. The coupling assurance assembly of claim 17, wherein the shaft is received within the yoke bore and moves the blocking arm of the spring clip from the first position to the second position.

19. The coupling assurance assembly of claim 18, wherein the cross hole and notch are aligned with the shaft received in the yoke bore.

20. The coupling assurance assembly of claim 18, wherein the shaft includes a retaining slot configured to receive a portion of the blocking arm of the spring clip.
